(19) United States
(12) Patent Application Publication
(10) Pub. No.: US 2025/0180157 A1
(43) Pub. Date: Jun. 5, 2025

(54) TRESTLE BASE AND TRESTLE

(71) Applicants: Sunstack, LLC, Plainfield, NJ (US); Roof and Solar Technologies Inc.DBA Integrity Solar Mounts, Poway, CA (US)

(72) Inventor: Shuichi KOBAYASHI, Poway, CA (US)

(21) Appl. No.: 18/951,805

(22) Filed: Nov. 19, 2024

(30) Foreign Application Priority Data
Nov. 30, 2023 (JP) 2023-202739

(51) Int. Cl. F16M 11/24

(52) U.S. Cl. CPC F16M 11/24; F16M 2200/08

(57) ABSTRACT

Provided are a trestle base and a trestle whereby fixing strength can be obtained with a small fixing member. The trestle base is for fixing an installation object to be installed on a roof surface of a building. The trestle base includes a bottom plate and a standing plate. The bottom plate has mounting holes. The standing plate is erected on the bottom plate and supports a fixing unit for fixing the installation object. A cross-section of the bottom plate and the standing plate is formed in a T shape.

### CROSS-REFERENCE TO RELATED APPLICATIONS

Error! No sequence specified. This application claims the benefit of Japanese Patent Application No. 2023-202739, filed on Nov. 30, 2023, the entire disclosure of which is incorporated by reference herein.

### FIELD OF THE DISCLOSURE

The present disclosure relates generally to a trestle base, and a trestle.

### BACKGROUND

Unexamined Japanese Patent Application Publication No. 2006-057357 describes a mounting structure for a functional panel in which a crosspiece for supporting the functional panel is fixed, via a fixture, to a support piece provided on a support tile. In the disclosure described in Unexamined Japanese Patent Application Publication No. 2006-057357, the fixture is attached by a bolt to the support piece provided on the support tile and, also, the crosspiece is attached by a bis to the fixture.

In the disclosure described in Unexamined Japanese Patent Application Publication No. 2006-057357, the support piece is attached to the support tile and the crosspiece is fixed via the fixture. In order to obtain fixing strength, the size of the fixing member, such as the support piece, must be increased. When the size of the fixing member is increased, the transport efficiency of the fixing member decreases. As such, there is a demand for obtaining fixing strength with a small fixing member.

The present disclosure is made with the view of the above situation, and an objective of the present disclosure is to provide a trestle base and a trestle whereby fixing strength can be obtained with a small fixing member.

### SUMMARY

In order to achieve the above-described objective, a trestle base according to the present disclosure is a trestle base for fixing an installation object to be installed on a roof surface of a building and include:
a bottom plate having mounting holes; and
a standing plate that is erected on the bottom plate and that supports a fixing unit for fixing the installation object,
wherein a cross-section of the bottom plate and the standing plate is formed in a T shape.

The mounting holes may include a long hole extending in a direction perpendicular to the standing plate.

The bottom plate may include a first region and a second region, and
the standing plate may be erected between the first region and the second region of the bottom plate.

Each of the first region and the second region may have one or plurality of the mounting holes.

The standing plate may include a height direction adjusting groove extending in a height direction, and
a fastener for mounting the fixing unit may be inserted into the height direction adjusting groove, and height of the fixing unit may be adjusted.

A back surface of the bottom plate may have a plurality of grooves.

In order to achieve the above-described objective, a trestle according to the present disclosure includes:
the trestle base; and
a pedestal mounted on a back surface of the bottom plate and having a plurality of grooves.

The trestle may include a fixing unit that is mounted on the trestle base and that fixes the installation object to be installed on a roof surface of the building.

The trestle base may be adjustable in an eave-ridge direction with respect to the pedestal, and
when the trestle base is adjusted to a ridge side, one end on a ridge side of the pedestal may be located at a same position as one end on a ridge side of the trestle base or arranged on a ridge side of one end on a ridge side of the trestle base.

When the trestle base is adjusted to an eave side, the other end on an eave side of the trestle base may be arranged on an eave side of the other end on an eave side of the pedestal.

According to the present disclosure, a trestle base and a trestle can be provided whereby fixing strength can be obtained with a small fixing member.

### BRIEF DESCRIPTION OF DRAWINGS

A more complete understanding of this application can be obtained when the following detailed description is considered in conjunction with the following drawings, in which:

FIG. 1 is a back view of a trestle according to an embodiment;

FIG. 2 is a side view of the trestle according to the embodiment;

FIG. 3A is a top view of a pedestal according to the embodiment;

FIG. 3B is a side view of the pedestal;

FIG. 4 is a perspective view of the trestle base according to the embodiment;

FIG. 5A is a side view of the trestle base according to the embodiment;

FIG. 5B is a top view of the trestle base;

FIG. 6 is a diagram illustrating that the pedestal is placed on a roof surface according to the embodiment;

FIG. 7 is a diagram illustrating that the trestle base is placed on the roof surface according to the embodiment;

FIG. 8 is a diagram illustrating that the trestle base is mounted on the roof surface according to the embodiment;

FIG. 9 is a perspective view of a trestle base according to a modified example;

FIG. 10 is another perspective view of the trestle base according to the modified example; and

FIG. 11 is a top view of a pedestal according to another modified example.

### DETAILED DESCRIPTION OF THE PREFERRED EMBODIMENTS

Hereinafter, embodiments of the present disclosure are described while referencing the drawings. Note that, to facilitate comprehension, XYZ coordinates that are orthogonal to each other are set and appropriately referenced. An XY plane of the XYZ coordinates is a plane parallel to a roof surface R on which a trestle 1 is to be installed. A Z-axis direction is a direction parallel to a height direction H from the roof surface R. In the present embodiment, an eave-ridge direction, which is a direction from the ridges to the eaves of a building, is the same direction as an X-axis direction.

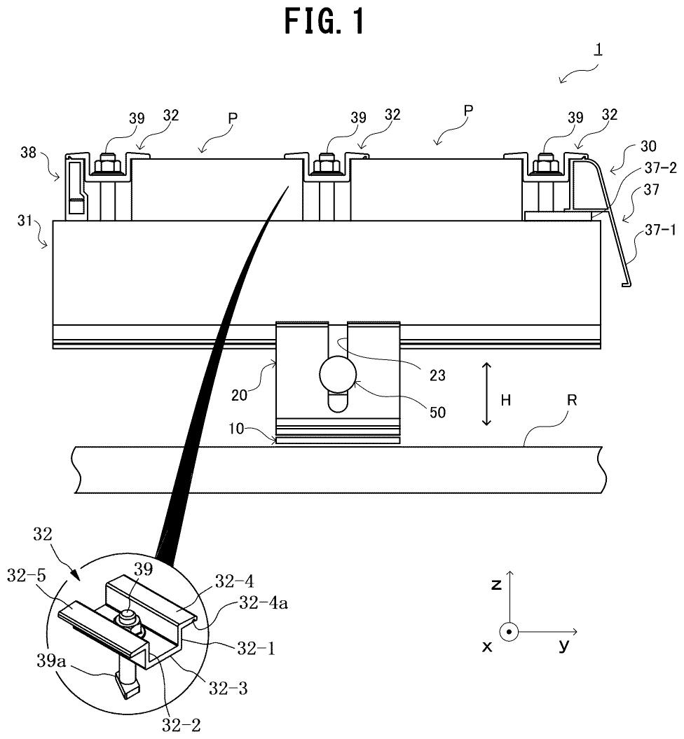

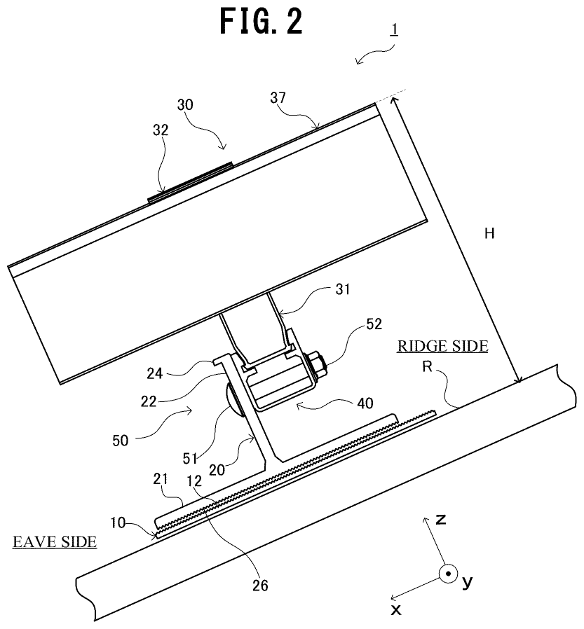

As illustrated in FIGS. 1 and 2, the trestle 1 is, for example, mounted on a roof surface R of a building and is used to support a solar panel P, as an installation object, to be installed on the roof surface R. Note that, in the present embodiment, the building on which the trestle 1 is mounted is a house that includes ridges and eaves of the roof. The trestle 1 according to the present embodiment includes a pedestal 10, a trestle base 20, a fixing unit 30, a receiving member 40, and a first fastener 50.

The fixing unit 30 is fixed to the receiving member 40 by the first fastener 50, and fixes the solar panel P. The fixing unit 30 includes an installation object disposing member 31, a fixing member 32, a cover 37, a fixing member receiving member 38, and a second fastener 39. Note that the fixing unit 30 does not have to include the cover 37, and the cover 37 may be replaced by the fixing member receiving member 38. In one example, the various components of the fixing unit 30 are formed from a metal. However, the present disclosure is not limited thereto. The various components of the fixing unit 30 may be formed from a material other than metal. For example, the various components of the fixing unit 30 may be formed from materials that have high rigidity, such as resins, ceramics, or the like. A portion of the various components of the fixing unit 30 may be formed from a different material. However, it is preferable that the various components of the fixing unit 30 are formed from a metal, and it is more preferable that all of the various components of the fixing unit 30 are formed from the same metal material.

In the present embodiment, the installation object disposing member 31 is a horizontal beam that extends in a Y-axis direction. The installation object disposing member 31 is formed such that an XZ cross-section thereof has a rectangular prismatic shape in which the Z-axis direction is the longitudinal direction. In one example, the installation object disposing member 31 is formed by extruding a metal. Specifically, the installation object disposing member 31 is formed by extruding aluminum, for example. A fixing member attachment groove is formed, on an upper surface on the +Z side of the installation object disposing member 31, along the Y-axis direction that is orthogonal to the eave-ridge direction, which is the direction from the ridges to the eaves of the building. Note that, in the present embodiment, the installation object disposing member 31 is a horizontal beam that extends in a direction orthogonal to the eave-ridge direction. However, the present disclosure is not limited thereto. The installation object disposing member 31 may be a beam other than a horizontal beam. For example, the installation object disposing member 31 may be a vertical beam that extends in the same direction as the eave-ridge direction. Additionally, the installation object disposing member 31 may be a beam, other than a horizontal beam or a vertical beam, that extends in a direction crossing the eave-ridge direction.

The upper surface on the +Z side of the installation object disposing member 31 is a surface on which the solar panel P is disposed. The upper surface on the +Z side is formed as a surface parallel to the YZ plane so as to facilitate disposal of the solar panel P.

The fixing member 32 is a member that sandwiches the solar panel P disposed on the upper surface of the installation object disposing member 31 and that is fixed to the installation object disposing member 31. In the present embodiment, three of the fixing members 32 are provided, and the three fixing members 32 fix two of the solar panels P. Each of the fixing members 32 includes side walls 32-1, 32-2, a coupling plate 32-3, and extensions 32-4, 32-5.

Each of the side walls 32-1, 32-2 is formed in a plate shape parallel to the YZ plane.

The coupling plate 32-3 is formed in a plate shape parallel to the XY plane. The coupling plate 32-3 couples the side walls 32-1, 32-2. A hole into which the second fastener 39 is inserted is formed on the coupling plate 32-3.

The extension 32-4 extends from an upper end (+Z side end) of the side wall 32-1. The extension 32-4 holds down any of the solar panel P, the cover 37, and the fixing member receiving member 38 against the installation object disposing member 31. An engaged portion 32-4a is formed on a lower surface on the −Z side of the extension 32-4.

The extension 32-5 extends from an upper end (+Z side end) of the side wall 32-2 in a direction opposite the extending direction of the extension 32-4. The extension 32-5 holds down any of the solar panel P, the cover 37, and the fixing member receiving member 38 against the installation object disposing member 31. Different from the extension 32-4, an engaged portion is not formed on the lower surface on the −Z side of the extension 32-5.

The cover 37 covers the +Y side end of the installation object disposing member 31. The cover 37 is constituted from an electrically conductive material. In one example, the cover 37 is formed by extruding a metal. Specifically, in one example, the cover 37 is formed by extruding aluminum and, then, subjecting the surface thereof to black color alumite treatment. As a result, the silver color, which is the color of the aluminum itself, is covered. This cover 37 includes a cover main body 37-1 and a spacer 37-2.

The second fastener 39 sandwiches the solar panel P by the installation object disposing member 31 and the fixing member 32, and fastens the installation object disposing member 31 and the fixing member 32.

The receiving member 40 receives the fixing unit 30 from below. In one example, the receiving member 40 is formed by extruding a metal. Specifically, the receiving member 40 is formed by extruding aluminum, for example.

The first fastener 50 includes a bolt 51 and a nut 52. In one example, the bolt 51 is constituted from a bolt or a screw. In the present embodiment, the bolt 51 of the first fastener 50 is screwed into the nut 52. However, the present disclosure is not limited thereto. For example, the hole of the receiving member 40 may be configured as a screw hole, and the bolt 51 may be screwed into this screw hole. In such a case, the nut 52 can be omitted, and the first fastener 50 is configured from only the bolt 51.

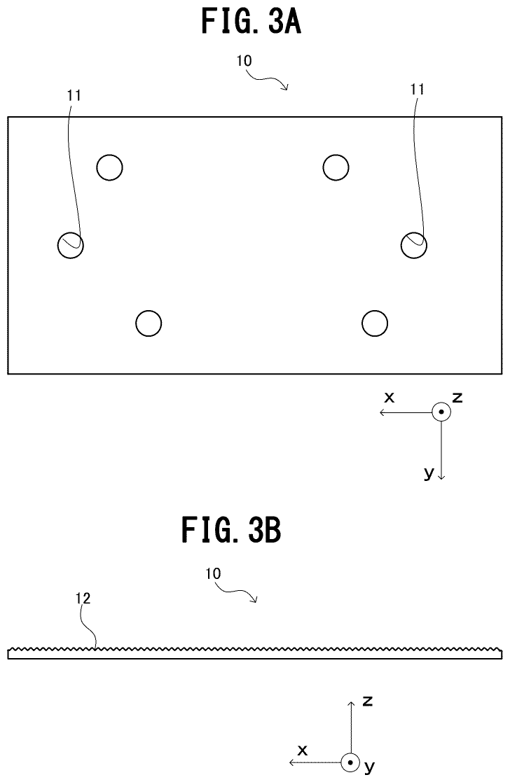

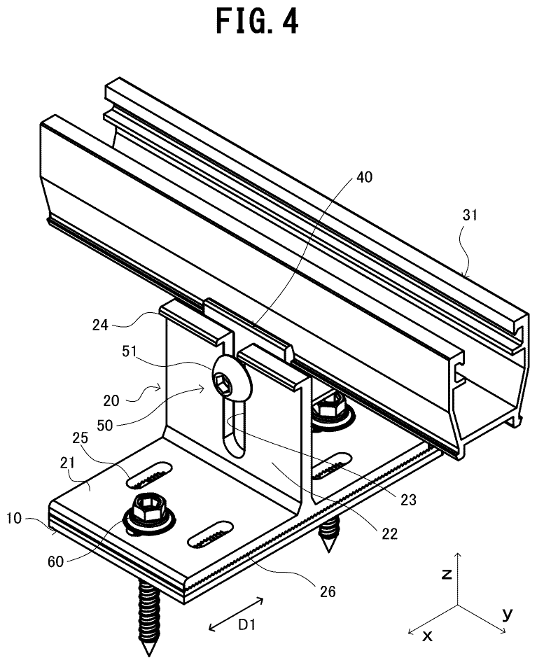

As illustrated in FIGS. 3A and 3B, the pedestal 10 includes a sheet that has a rectangular shape and that is made from butyl rubber, and on the pedestal 10, a plurality of circular mounting holes 11 is formed and a plurality of grooves 12 extending in the Y-axis direction thereof is formed on the surface. The plurality of grooves 12 has a non-slip effect. Note that the shape of the pedestal 10 illustrated in the drawings is an example, and the shape is not limited thereto. Additionally, the material of the pedestal 10 is not limited to butyl rubber, and may be a material other than butyl rubber. A base mounting fastener 60 illustrated in FIG. 4 is inserted into a mounting hole 11.

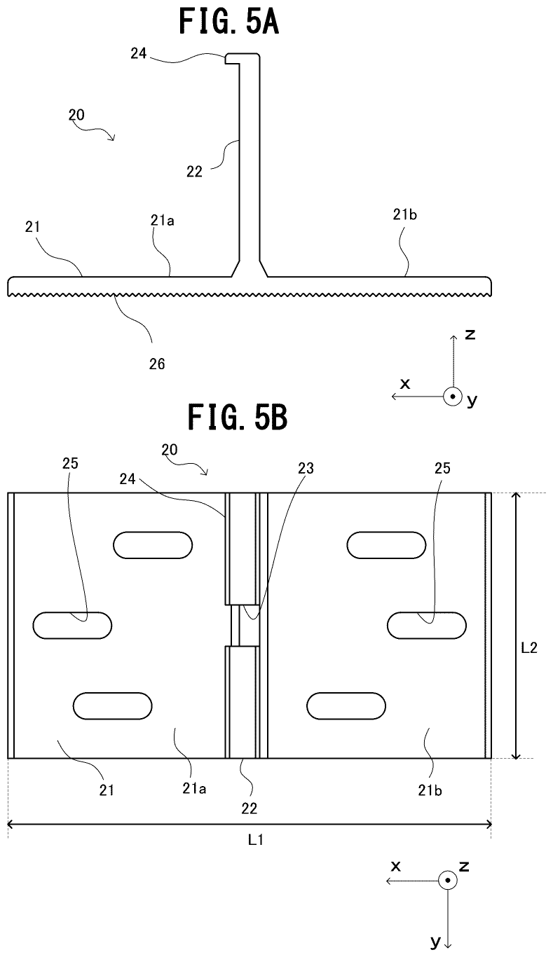

As illustrated in FIGS. 4 and 5A, the trestle base 20 is a T-shaped angle bracket in which the XZ cross-section is formed in a T shape and that supports the receiving member 40 near an upper end of the T shape. The trestle base 20 includes a bottom plate 21, a standing plate 22, a height direction adjusting groove 23 (receiving member attacher), a protrusion 24, and mounting holes 25. The pedestal 10 is attached on the back surface of the bottom plate 21 of the trestle base 20, and the trestle base 20 is mounted on the roof surface R of the building via the pedestal 10.

The bottom plate 21 is a plate-shaped member formed in a rectangle, and on the back surface of the bottom plate 21, a plurality of grooves 26 extending in the Y-axis direction is formed. The plurality of grooves 26 has a non-slip effect. Additionally, as illustrated in FIG. 5B, length L1 in the X-axis direction of the bottom plate 21 is longer than length L2 in the Y-axis direction of the bottom plate 21. Additionally, the bottom plate 21 includes a first region 21a and a second region 21b. In each of the first region 21a and the second region 21b, one or a plurality of mounting holes 25 is formed. In this example, in each of the first region 21a and the second region 21b, three mounting holes 25 are formed.

The standing plate 22 is a plate-shaped member erected between the first region 21a and the second region 21b of the bottom plate 21. In one example, the bottom plate 21 and the standing plate 22 are integrally formed with each other by extruding a metal. Specifically, the bottom plate 21 and the standing plate 22 are formed by extruding aluminum, for example.

As illustrated in FIG. 4, the height direction adjusting groove 23 (the receiving member attacher) is a groove that is formed in the standing plate 22 and that extends long in the height direction H. The first fastener 50 is inserted into the height direction adjusting groove 23. The height direction adjusting groove 23 is used to adjust a position in the height direction H of the receiving member 40.

The protrusion 24 protrudes in the +X direction from the upper end (the +Z side end) of the trestle base 20. A bolt head of the first fastener 50 hooks on the protrusion 24 and, thus, the protrusion 24 prevents the first fastener 50 from separating upward (the +Z direction) from the height direction adjusting groove 23. Note that, in the present embodiment, the protrusion 24 protrudes in the +X direction from the upper end (the +Z side end) of the trestle base 20. However, the present disclosure is not limited thereto. The protrusion 24 may protrude in the −X direction, opposite the +X direction, from the upper end (the +Z side end) of the trestle base 20. However, when the protrusion 24 protrudes in the −X direction, the protrusion 24 may interfere with the receiving member 40. As such, the protrusion 24 preferably protrudes in the +X direction from the upper end (the +Z side end) of the trestle base 20.

The mounting holes 25 include long holes extending in the X-axis direction. A base mounting fastener 60 is inserted into a mounting hole 25. As a result, it is possible to temporarily fix the trestle base 20 by the base mounting fasteners 60 and adjust the position of the trestle base 20 in a first direction D1 that is parallel to the X-axis direction.

A construction method of the trestle 1 configured as described above is described while referencing the drawings.

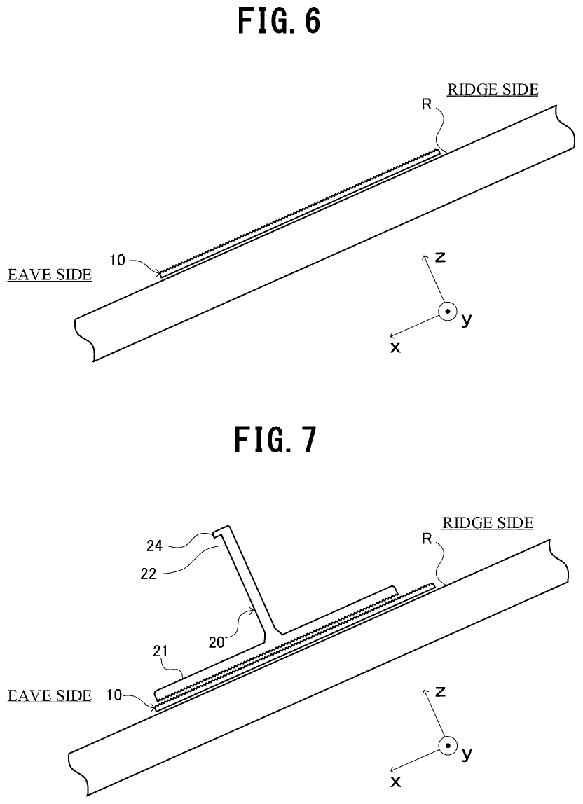

When installing the trestle 1 and the solar panel P on the roof surface R of the building, a worker that installs the trestle 1 on the roof surface R first places the pedestal 10 on the roof surface R, as illustrated in FIG. 6. The pedestal 10 includes a sheet made from butyl rubber.

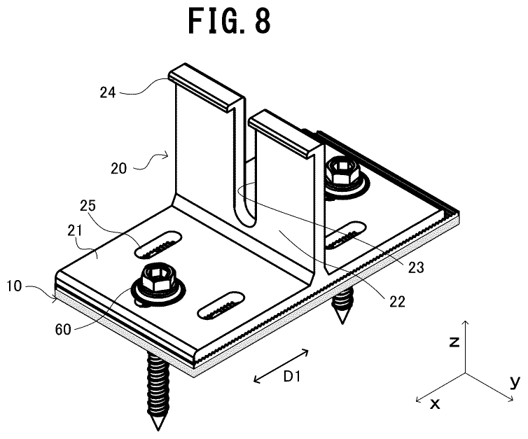

Next, the worker mounts the trestle base 20 on the roof surface R. Specifically, firstly, the worker arranges the trestle base 20 on the roof surface R, as illustrated in FIG. 7 and temporarily fixes the trestle base 20 to the roof surface R by the base mounting fasteners 60, as illustrated in FIG. 8. At this time, the worker, by shifting the trestle base 20 in the first direction D1, adjusts an installation position to the eave side or the ridge side. After the adjustment, the worker, by tightening the base mounting fasteners 60, fixes the trestle base 20 to the roof surface R. The number of the base mounting fasteners 60 is determined based on required fixing strength. For example, when the trestle base 20 is fixed to a rafter, the trestle base 20 is fixed by two base mounting fasteners 60. Additionally, when the trestle base 20 is fixed to a sheathing roof board, the trestle base 20 is fixed by five base mounting fasteners 60.

Next, as illustrated in FIG. 4, the worker temporarily fixes the receiving member 40 to the trestle base 20 using the first fastener 50.

Next, the worker fits the installation object disposing member 31, to which the solar panel P is not attached, to the receiving member 40 from the +Z side (the upper side).

Next, the worker adjusts a height level from the roof surface R to the upper end of the installation object disposing member 31 to a desired height level. Then, the worker fixes the receiving member 40 to the trestle base 20 using the first fastener 50.

Next, as illustrated in FIG. 1, the worker arranges the solar panel P, the cover 37 including the spacer 37-2, and the fixing member receiving member 38 on the upper surface of the installation object disposing member 31. Then, the worker fixes, with respect to the installation object disposing member 31, the solar panel P, the cover 37, and the fixing member receiving member 38 using a plurality of the fixing member 32. At this time, the worker can adjust the positions of the plurality of the fixing member 32 along the fixing member attachment groove 31a to strongly fix the solar panel P.

Thus, as illustrated in FIGS. 1 and 2, the work of installing the trestle 1 and the solar panel P on the roof surface R of the building is ended.

As described above, in the trestle 1 and the trestle base 20 according to the present embodiment, the cross-section of the bottom plate 21 and the standing plate 22 is formed in a T shape and, as such, fixing strength can be obtained with a small fixing member. Additionally, since the trestle base 20 has the mounting holes 25 including long holes extending in the X-axis direction, the worker can, by shifting the trestle base 20 in the first direction D1, adjust the installation position to the eave side or the ridge side. Additionally, the standing plate 22 is erected between the first region 21a and the second region 21b of the bottom plate 21, and in each of the first region 21a and the second region 21b, one or a plurality of mounting holes 25 is formed. As a result, the trestle base 20 can be stably fixed to the roof surface R of the building. By the standing plate 22 including the height direction adjusting groove 23 extending in the height direction, the position in the height direction H of the receiving member 40 can be adjusted. Additionally, by the plurality of grooves 26 being formed on the back surface of the bottom plate 21, the trestle base 20 can be fixed so as not to slip with respect to the roof surface R of the building.

### Modified Examples

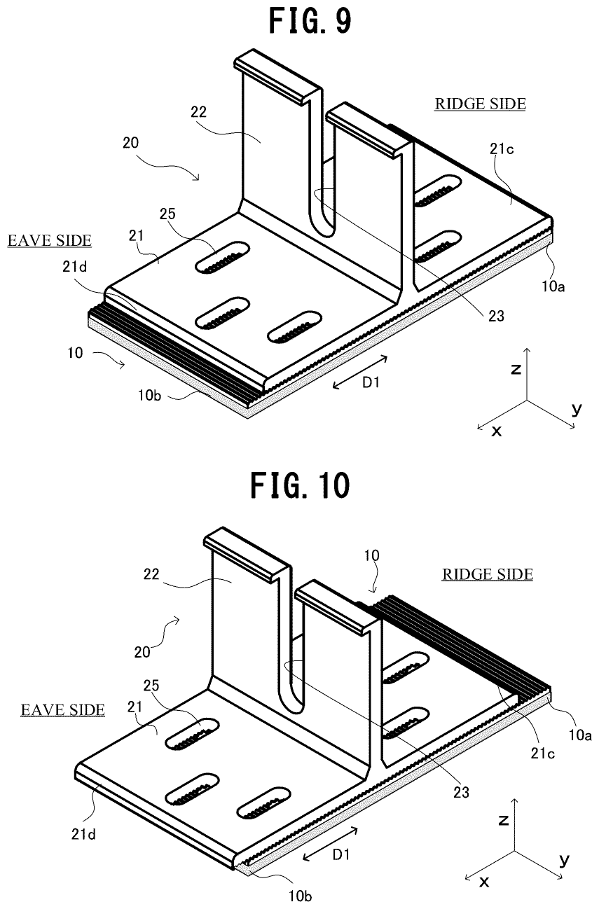

In the embodiment described above, an example is described in which the worker, by shifting the trestle base 20 in the first direction D1, adjusts the installation position to the eave side or the ridge side. At this time, when as illustrated in FIG. 9, the installation position of the trestle base 20 is adjusted to the ridge side with respect to the pedestal 10, one end 10a on the ridge side of the pedestal 10 is located at the same position as one end 21c on the ridge side of the trestle base 20 or arranged on the ridge side of the one end 21c on the ridge side of the trestle base 20. This arrangement is achieved by setting the size and shape of the pedestal 10 and the positions of the mounting holes 11 of the pedestal 10 such that when the positions of the mounting holes 11 of the pedestal 10 and the positions of the ridge sides of the mounting holes 25 of the trestle base 20 are aligned, the one end 10a on the ridge side of the pedestal 10 is located at the same position as the one end 21c on the ridge side of the trestle base 20 or arranged on the ridge side of the one end 21c on the ridge side of the trestle base 20. By configuring in this manner, it is possible to prevent rainwater from staying between the one end 21c on the ridge side of the trestle base 20 and the roof surface R of the building. Additionally, when as illustrated in FIG. 10, the trestle base 20 is adjusted to the eave side, the other end 21d on the eave side of the trestle base 20 is preferably arranged on the eave side of the other end 10b on the eave side of the pedestal 10. By configuring in this manner, the size of the pedestal 10 can be reduced and cost can be suppressed.

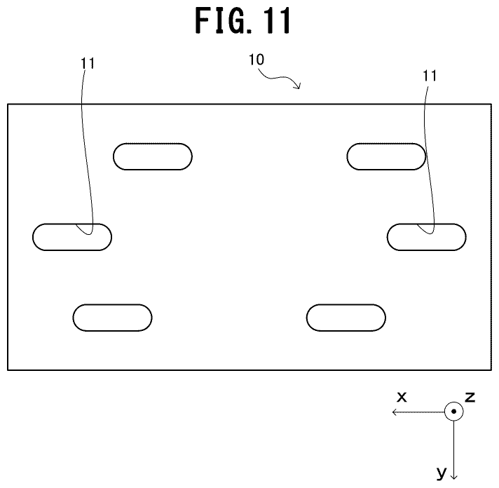

In the trestle base 20 of the above-described embodiment, an example is described in which the pedestal 10 has a plurality of circular mounting holes 11. However, the shape of the mounting holes 11 formed on the pedestal 10 is not limited to a specific shape. For example, as illustrated in FIG. 11, the pedestal 10 may have mounting holes 11 including long holes extending in the X-axis direction. By configuring in this manner, the worker can, by shifting the trestle base 20 in the first direction D1, easily adjust the installation position to the eave side or the ridge side.

The foregoing describes some example embodiments for explanatory purposes. Although the foregoing discussion has presented specific embodiments, persons skilled in the art will recognize that changes may be made in form and detail without departing from the broader spirit and scope of the disclosure. Accordingly, the specification and drawings are to be regarded in an illustrative rather than a restrictive sense. This detailed description, therefore, is not to be taken in a limiting sense, and the scope of the disclosure is defined only by the included claims, along with the full range of equivalents to which such claims are entitled.
1 Trestle
10 Pedestal
10a One end
10b The other end
11 Mounting hole
12 Groove
20 Trestle base
21 Bottom plate
21a First region
21b Second region
21c One end
21d The other end
22 Standing plate
23 Height direction adjusting groove (receiving member attacher)
24 Protrusion
25 Mounting hole
26 Groove
30 Fixing unit
31 Installation object disposing member
31a Fixing member attachment groove
32 Fixing member
32-1, 32-2 Side wall
32-3 Coupling plate
32-4, 32-5 Extension
32-4a Engaged portion
37 Cover
37-1 Cover main body
37-2 Spacer
38 Fixing member receiving member
39 Second fastener
40 Receiving member
50 First fastener
51 Bolt
52 Nut
60 Base mounting fastener
H Height direction
P Solar panel (installation object)
R Roof surface
L1, L2 Length
D1 First direction

What is claimed is:

1. A trestle base for fixing an installation object to be installed on a roof surface of a building, the trestle base comprising:
a bottom plate on which mounting holes are provided;
a standing plate that is erected on the bottom plate and that supports a fixing unit for fixing the installation object,
wherein a cross-section of the bottom plate and the standing plate is formed in a T shape.

2. The trestle base according to claim 1, wherein
the mounting holes include a long hole extending in a direction perpendicular to the standing plate.

3. The trestle base according to claim 1, wherein
the bottom plate includes a first region and a second region, and
the standing plate is erected between the first region and the second region of the bottom plate.

4. The trestle base according to claim 3, wherein
each of the first region and the second region has one or plurality of the mounting holes.

5. The trestle base according to claim 1, wherein
the standing plate includes a height direction adjusting groove extending in a height direction, and
a fastener for mounting the fixing unit is inserted into the height direction adjusting groove, and height of the fixing unit is adjusted.

6. The trestle base according to claim 1, wherein
a back surface of the bottom plate has a plurality of grooves.

7. A trestle, comprising:
the trestle base according to claim 1; and
a pedestal mounted on a back surface of the bottom plate and having a plurality of grooves.

8. The trestle according to claim 7, comprising:
a fixing unit that is mounted on the trestle base and that fixes the installation object to be installed on a roof surface of the building.

9. The trestle according to claim 7, wherein
the trestle base is adjustable in an eave-ridge direction with respect to the pedestal, and
when the trestle base is adjusted to a ridge side, one end on a ridge side of the pedestal is located at a same position as one end on a ridge side of the trestle base or arranged on a ridge side of one end on a ridge side of the trestle base.

10. The trestle according to claim 9, wherein
when the trestle base is adjusted to an eave side, the other end on an eave side of the trestle base is arranged on an eave side of the other end on an eave side of the pedestal.

11. The trestle base according to claim 2, wherein
the bottom plate includes a first region and a second region, and
the standing plate is erected between the first region and the second region of the bottom plate.

12. The trestle base according to claim 2, wherein
the standing plate includes a height direction adjusting groove extending in a height direction, and
a fastener for mounting the fixing unit is inserted into the height direction adjusting groove, and height of the fixing unit is adjusted.

13. The trestle base according to claim 2, wherein
a back surface of the bottom plate has a plurality of grooves.

14. A trestle, comprising:
the trestle base according to claim 2; and
a pedestal mounted on a back surface of the bottom plate and having a plurality of grooves.
